(19) United States
(12) Patent Application Publication
(10) Pub. No.: US 2010/0128951 A1
(43) Pub. Date: May 27, 2010

(54) Radiotherapeutic Apparatus and Methods

(75) Inventor: Kevin John Brown, West Sussex (GB)

Correspondence Address: WESTMAN CHAMPLIN & KELLY, P.A., SUITE 1400, 900 SECOND AVENUE SOUTH, MINNEAPOLIS, MN, 55402, US

(73) Assignee: ELEKTA AB (PUBL), Stockholm (SE)

(21) Appl. No.: 12/596,042

(22) PCT Filed: Apr. 18, 2007
(86) PCT No.: PCT/EP2007/003395

§ 371 Date: Oct. 15, 2009

(51) Int. Cl. G06K 9/00

(52) U.S. Cl. 382/131; 382/128

(57) ABSTRACT

A treatment planning apparatus for radiation treatment is described, adapted to accept a treatment plan comprising (i) a prior image of a region to be treated and a plurality of dose locations within the prior image, and (ii) a current image of the region to be treated, the apparatus comprising an associating means arranged, for each dose location, to locate an anatomical structure in the prior image proximate that dose location; a comparator for comparing the prior image and the current image, locating in the current image at least those anatomical structures that are associated with a dose location, and determining a transformation between the prior image and the current image for each anatomical structure; and a processing means for determining a current dose location by applying to each dose location the transformation determined in respect of the associated anatomical structure. This is particularly useful for the neck region of a patient, where the likelihood and magnitude of movements are both high, but there are plenty of distinguishable anatomical features in the form of the vertebrae.

### FIELD OF THE INVENTION

The present invention relates to apparatus and methods for radiation treatment.

### BACKGROUND ART

The Leksell™ Gamma Knife™ (LGK), and the more recently released Perfexion™ system, are radiation treatment systems that employ a large number of individual radiation, sources that are arrayed in a hemisphere, and are all collimated to direct a beam of radiation at a single location. As a result, they create a high dose of radiation in a substantially spherical volume around that location and only a low background dose around that volume. Shutters for the sources enable a patient to be moved into position and a prescribed dose of radiation to be delivered to a defined volume within the patient. Treatment volumes that are not spherical or that are larger than the defined volume are dealt with by repeated doses that build up to the prescribed dose.

Until recently, the LGK has been used mainly to treat the head area of a patient, due to volume limitations that flow from the hemispherical structure that carries the sources. More recent versions of the LGK however (in particular the Perfexion™ system) are designed for a larger treatable volume and are able to treat regions such as the neck and upper spine.

Existing systems have allowed for the distribution of dose locations to be corrected by way of what is known as a ‘rigid body’ transformation in which all the dose locations are translated by the same amount to take account of movement of the skull between an initial imaging step and the treatment.

### SUMMARY OF THE INVENTION

The extension of the potential treatment volume to include the head and neck introduces a potential problem, in that these areas are apt to display a greater degree of variance with time as a result of movement by the patient. This leads to deformation of the treatment volume as well as translation. This is not a problem for regions inside the skull as no deformations take place.

Previous techniques based on ‘rigid body’ transformations are not useful since translating all the dose locations by the same amount is not generally appropriate for the head and neck regions as a result of the potential for deformation as well as translation, a so called ‘non-rigid body’ transformation. A generic non-rigid body transformation is however too complex to perform swiftly enough for radiation treatment applications.

The present invention therefore provides a treatment planning apparatus for radiation treatment, adapted to accept a treatment plan comprising (i) a prior image of a region to be treated and a plurality of dose locations within the prior image, and (ii) a current image of the region to be treated, the apparatus comprising an associating means arranged, for each dose location, to locate an anatomical structure in the prior image proximate that dose location; a comparator for comparing the prior image and the current image, locating in the current image at least those anatomical structures that are associated with a dose location, and determining a transformation between the prior image and the current image for each anatomical structure; and a processing means for determining a current dose location by applying to each dose location the transformation determined in respect of the associated anatomical structure.

This is simply not possible in relation to other types of radiation treatment in which a shaped beam is directed at an isocentre within the patient from a range of different directions as its source rotates around the isocentre. The radiation from such a delivery method does not arrive as a plurality of dose locations; it arrives as a plurality of beam paths that pass through the patient.

The prior image and the current image are ideally three-dimensional, such as from cone beam computed tomography scanning.

The anatomical structures in the prior image can be located through manual identification by a user, or they can be identified using an automated image analysis tool. An example of such a tool is one which allows selection of a number of predefined volumes of the prior image, including and surrounding each dose location.

The associating means and the comparator can be in the form of programs executed by the same processing means. This allows the entire process to be integrated into a single computing device. Alternatively, the tasks can be spread over a number of such computing devices in order to speed processing.

The invention further provides a treatment planning apparatus as defined above associated with a radiotherapeutic apparatus comprising a plurality of individual radiation sources arrayed in a hemisphere, each source being collimated to direct a beam of radiation at a single location within the hemisphere. The radiation sources are preferably decaying isotopes. The Leksell Gamma Knife is an example of such an apparatus.

This invention is particularly useful for the neck region of a patient, where the likelihood and magnitude of non-rigid movements are both high, but there are plenty of distinguishable anatomical features in the form of the vertebrae and air/tissue interfaces.

### BRIEF DESCRIPTION OF THE DRAWINGS

An embodiment of the present invention will now be described by way of example, with reference to the accompanying figures in which;

FIG. 1 shows a schematic illustration of a neck region with a planned treatment; and

FIG. 2 shows the same neck region after movement.

### DETAILED DESCRIPTION OF THE EMBODIMENTS

Developments in relation to imaging during the time of treatment, generally known as Image Guided RadioTherapy (IGRT), have made available information not only about the displacement of the patient but also the local deformation of non rigid structures. Such deformations can be significant, such as in the neck region. When a radiation dose is delivered using a shaped field (such as a linear accelerator fitted with a Multi-Leaf Collimator), the necessary modification of the treatment to accommodate these deformations is quite complex. However, when the dose is delivered using a sequence of near spherical ‘shots’ (such as in the LGK) then the required modifications to the dose distribution can be more straightforward.

With the LGK or Perfexion, the dose is delivered by a sequence of shots. Each shot has a predefined position in the treatment planning image. According to the present invention, we displace each individual shot by the local displacement of the anatomy at that position in the image, rather than displace the entire plan or set of shots by the same amount.

This is particularly applicable in the neck, which is non rigid and can be subject to significant deformations between the planning image and the time of treatment. Fortunately, the neck has lots of visible anatomy such as the neck vertebrae, which makes it possible to determine the local displacements. This could be done performing a rigid body registration using the anatomy local to the planned position for the shot, or by performing one deformable registration of the whole image set and then determining the displacements from the result.

This is enabled by the use of 3D imaging e.g. cone beam computed tomography (CBCT) at the time of treatment. It is a simple way of avoiding a complete re-plan of the entire treatment, yet will keep each shot delivered to the right place in the anatomy.

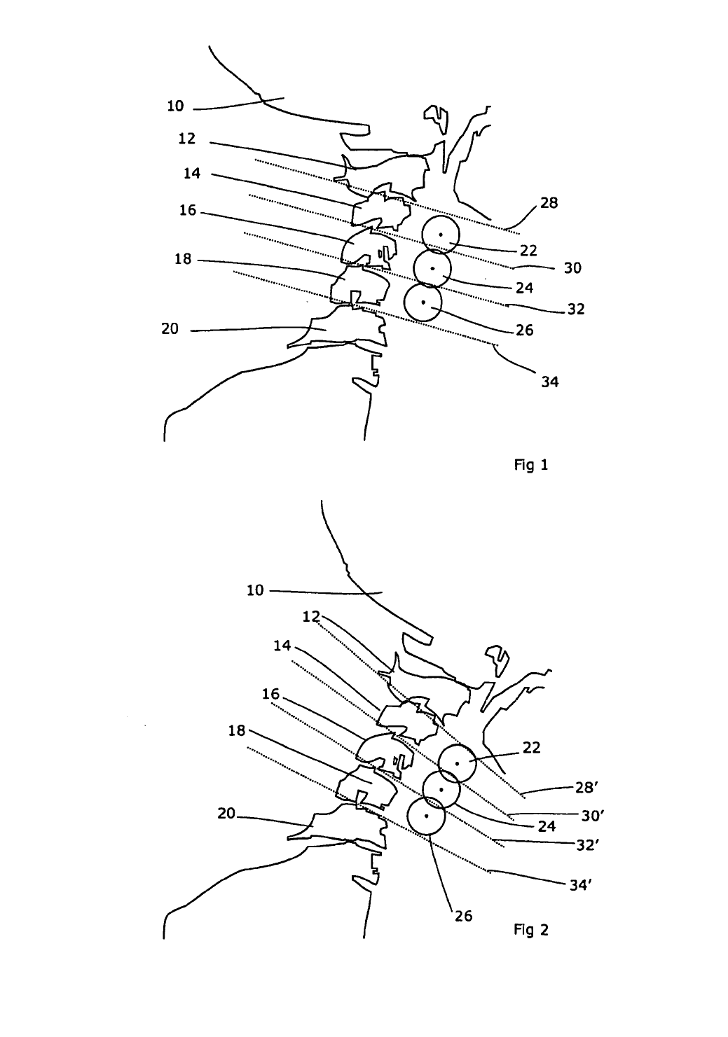

FIGS. 1 and 2 show the process. FIG. 1 is the prior image, projected as a two-dimensional slice for reasons of clarity. A section of skull 10 is clearly visible, together with successive vertebrae 12, 14, 16, 18 and 20. A series of three doses 22, 24 and 26 have been prescribed and these are shown in front of the line of vertebrae. The first step is to locate a visible anatomical feature near to each of the dose locations; in the simple example shown in FIG. 1 this is clearly the vertebrae nearest each dose location and the associations can be made as follows:

| Dose location | Feature |
|---|---|
| 22 | 14 |
| 24 | 16 |
| 26 | 18 |

An automated image analysis algorithm will however choose image features from the specific image to hand. This could be supplemented or replaced by a user-operated manual association function, allowing each dose location to be selected together with an image feature to associate therewith.

FIG. 2 shows the current image of the same patient. Between the two images, the patient has moved their neck, by tilting their head forwards. This results in each vertebrae being rotated by a few degrees and moved slightly.

Guidelines 28, 30, 32 and 34 are positioned in FIG. 1 relative to the vertebrae 12, 14, 16 and 18, to indicate the position and orientation of the vertebra concerned. It can be seen that the corresponding guidelines 28′, 30′, 32′ and 34′ in FIG. 2 are angled relative to each other, showing the movement of the vertebrae. This movement can be detected by image analysis algorithms that compare the prior and the current image to yield a displacement vector and a rotation representing the movement of an image feature as between the two images.

Accordingly, the apparatus of the invention can then apply the same movement to each dose location as is applicable to the associated image feature. A change that is non-uniform over the image volume is therefore accommodated automatically and without the need for complex processing.

There will be a second order effect in that the applied displacements will change the local density of shots which will change the delivered dose. For example, comparing FIGS. 1 and 2 shows that the overlap between adjacent doses in greater in FIG. 2 than in FIG. 1. The magnitude of this effect will depend on the magnitude of the displacements, and may be below a threshold of significance. If not, it can be corrected by adjusting the applied dose at each shot by the change in shot density or a simple function thereof.

This technique is ideally suited to LGK type delivery, where each shot delivers its dose primarily to a single anatomical region, but might also apply to other radiation treatment apparatus that deliver the overall dose as a series of discrete localised sub-doses.

It will of course be understood that many variations may be made to the above-described embodiment without departing from the scope of the present invention.

1. A treatment planning apparatus for radiation treatment, adapted to accept a treatment plan comprising (i) a prior image of a region to be treated and a plurality of dose locations within the prior image, and (ii) a current image of the region to be treated,
the apparatus comprising:
associating means arranged to locate at least one anatomical structure in the prior image proximate a specified location in the image;
a comparator for comparing the prior image and the current image, locating in the current image the at least one anatomical structure associated with the specified location, and determining a transformation between the prior image and the current image for the at least one anatomical structure;
a processing means for determining a current dose location set by:
for each dose location, invoking the associating means, specifying that dose location, and
applying to each dose location the transformation determined in respect of the associated anatomical structure.

2. A treatment planning apparatus according to claim 1 in which the prior image and the current image are three-dimensional.

3. A treatment planning apparatus according to claim 2 in which the prior image and the current image are the result of cone beam computed tomography scanning.

4. A treatment planning apparatus according to any one of the preceding claims in which the anatomical structures in the prior image are located through manual identification by a user.

5. A treatment planning apparatus according to any one of claims 1 to 3 in which the anatomical structures in the prior image are located through automated image analysis.

6. A treatment planning apparatus according to any one of the preceding claims in which the associating means and the comparator are programs executed by the processing means.

7. A treatment planning apparatus according to any one of the preceding claims associated with a radiotherapeutic apparatus comprising a plurality of individual radiation sources arrayed in a hemisphere, each source being collimated to direct a beam of radiation at a single location within the hemisphere.

8. A treatment planning apparatus according to claim 7 in which the radiation sources are decaying isotopes.

9. A treatment planning apparatus according to any one of the preceding claims in which the prior image and the current image are images of the neck region of a patient.

10. A treatment planning apparatus according to claim 9 in which the anatomical structures include neck vertebrae.
